(19) United States
(12) Patent Application Publication
(10) Pub. No.: US 2013/0308628 A1
(43) Pub. Date: Nov. 21, 2013

(54) NAT TRAVERSAL FOR VOIP

(71) Applicants: Sunny MARUELI, Nes Ziona (IL); Ofer SAMOCHA, Rishon LeZion (IL)

(72) Inventors: Sunny MARUELI, Nes Ziona (IL); Ofer SAMOCHA, Rishon LeZion (IL)

(73) Assignee: VIBER MEDIA, INC., Limassol (CY)

(21) Appl. No.: 13/471,547

(22) Filed: May 15, 2012

(51) Int. Cl. H04L 12/66

(52) U.S. Cl. 370/352

(57) ABSTRACT

A method of communication between users' electronic communication devices connected to a network via NAT devices, comprising: sending a call request to a signaling server, locating a relay server IP address, sending the call request and the relay server IP address to the receiving device, sending the relay server IP address to the calling device, starting communication via the relay server and following said communication start: identifying and reporting by the devices' public and private addresses, establishing connectivity between the devices and continuing the communication in a peer-to-peer mode.

### TECHNOLOGY FIELD

The present invention relates to an improvement to VoIP communication, and more particularly to a NAT (Network Address Translator) traversal method in session initiation protocol, for improving the traversal of speech packets under the NAT firewall.

### BACKGROUND

NAT devices are commonly used to reduce the need for IP addresses in a quickly dwindling IPv4 address space, by allowing the use of private IP addresses on home and corporate networks behind routers with a single public IP address facing the public Internet. The internal network devices communicate with hosts on the external network by changing the source address of outgoing requests to that of the NAT device and relaying replies back to the originating device. This leaves the internal network ill-suited to host servers, as the NAT device has no automatic method of determining the internal host for which incoming packets are destined. This is not a problem for home users behind NAT devices doing general web access and e-mail. However, applications such as peer-to-peer file sharing, VoIP services and the online services of current generation video game consoles require clients to be servers as well, thereby posing a problem for users behind NAT devices, as incoming requests cannot be easily correlated to the proper internal host. Furthermore many of these types of services carry IP address and port number information in the application data, potentially requiring substitution or special traversal techniques for NAT traversal.

In voice over IP (VoIP), the media (voice, video) is usually transferred via UDP (User Datagram Protocol) packets between the peers participating in the conversation. With UDP, computer applications can send messages to other hosts on an Internet Protocol (IP) network without requiring prior communications to set up special transmission channels or data paths.

UDP uses a simple transmission model without implicit handshaking dialogues for providing reliability, ordering, or data integrity. Thus, UDP provides an unreliable service and messages may arrive out of order, appear duplicated, or go missing without notice. UDP assumes that error checking and correction is either not necessary or performed in the application, avoiding the overhead of such processing at the network interface level. Time-sensitive applications often use UDP because dropping packets is preferable to waiting for delayed packets, which may not be an option in a real-time system.

To improve quality (e.g. reduced latency, jitter) and reduce costs, it is preferable to connect the peers in a peer-to-peer connection. This is not a trivial task in today's world as (mainly) for reasons of limited public IP address availability most clients would be behind a NAT (network address translation) device such as a residential router connecting a home to the Internet. Such device allows multiple devices to share a single “public” IP address.

While NATs/firewalls play a very important role in securing and enhancing the usability of an internal network, they impose a significant problem in setting up VoIP calls between end users. Application developers cannot make assumptions about how traffic can pass into or out of these private networks.

NAT traversal for applications such as peer-to-peer file sharing, VoIP services and the online video games is complicated by many contributing factors:

### NATs Break VoIP Protocols

The idea of a NAT is to allow several devices to share a single public IP address. FIG. 1 shows a scenario where both parties are not NAT-aware. A router 125, such as a home router, using a public IP address 7.7.7.7 and a private IP address 192.168.0.1 connects several computers (110, 135) using private IP addresses (e.g. computer 110 has a private IP address 192.168.0.110). The router 125 allows computers 110, 135 to access the public Internet 145 by modifying each IP packet to and from these computers and/or by using a two-way mapping between private IP addresses and transport ports to the router's public IP address and transport ports. The rewriting of addresses by the NAT is usually performed using a lookup table, where mappings between internal address/port pairs and external address/port pairs are stored.

This technique facilitates sharing a single public IP address among many computers that use private IP addresses. However, this technique imposes a few problems for VoIP calls. User 110 wishes to makes a VoIP call to user 140 (connected to the Internet via a router 150), using RTP (Real Time Transport Protocol) from behind his NAT device. Assuming user 140 has reported its private IP address (10.0.0.140), e.g. using SIP, user 110 will attempt to send packets to this address via NAT device 125. 125 will modify the packet, sending it to the Internet 145. However, since the destination address for this packet (10.0.0.140) is not a valid public address, the packet will be dropped by some router 138.

NATs do not Communicate Packets from Unknown Sources

Even if 110 discovers the public address of NAT device 150, it still cannot reach 140 as a mapping is required for 150 to forward packets received on a specific port (and possibly coming from a specific source) to some device behind it. If a packet arrives “uninvited”, the packet is dropped by 150.

### NATs Close Inactive Connections

NAT devices do not keep mappings indefinitely (e.g. memory is limited). Therefore, entries are removed from the NAT's lookup table according to a policy such as time of inactivity, LRU cache management algorithm, or any other logic.

Standard solutions for the problem are available—e.g. STUN (Session Traversal Utilities for NAT), TURN (Traversal Using Relay NAT) and ICE (Interactive Connectivity Establishment). STUN lets the applications discover the public IP address and port mappings that the applications can use to communicate with its peer. TURN, on the other hand, allocates a public IP/port on a globally reachable server and uses it to relay media between communicating parties. ICE is a framework that defines how to use the STUN and TURN protocols to solve the NAT traversal problem, by choosing the best possible interconnection method between two users: Each client assigns a TURN relay address and checks its reflexive address with STUN. It adds to that its local address (the address of the network adapter). The peer does the same. Using a signaling protocol (such as SIP) the clients exchange these addresses. Now, the clients go over the list of addresses and try to connect. Once such a connection is established—they can start sending voice traffic.

### SUMMARY

A method of communication between users' electronic communication devices connected to a network via NAT devices, comprising sending a call request to a signaling server by a first electronic communication device connected to a network via NAT device to communicate with a second electronic communication device; locating by the signaling server a relay server IP address; sending by the signaling server said call request and said relay server IP address to said second electronic communication device connected to a network via NAT device; sending said relay server IP address to said first electronic communication device; starting communication between said first and second electronic communication devices via the relay server; and following said communication start: identifying by the relay server said first and second electronic communication devices public addresses; reporting by said first and second electronic communication devices their private IP addresses to said relay server; reporting by said relay server to each of said first and second electronic communication devices the public and private IP addresses of its peer; establishing connectivity by said first and second electronic communication devices; and continuing the communication between said first and second electronic communication devices via said reported public and private IP addresses in a peer-to-peer mode upon establishing connectivity.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 shows a scenario where both parties are not NAT-aware;

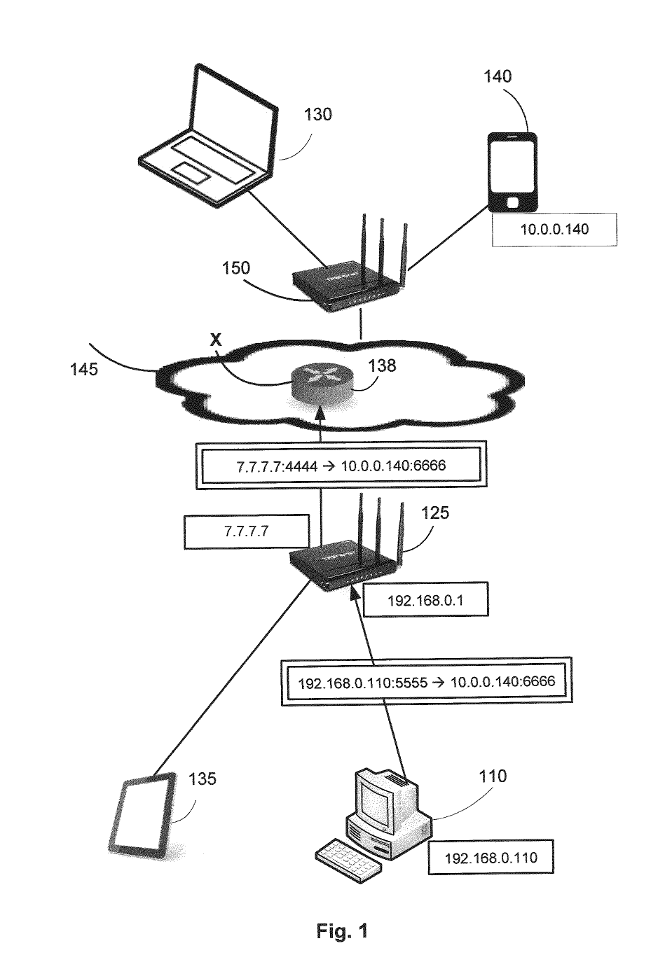

FIG. 2A is a schematic block diagram of the system and communication routes according to embodiments of the present invention;

FIG. 2B is a schematic block diagram of the system and communication routes according to other embodiments of the present invention; and

FIG. 3 is a flowchart outlining the method of NAT traversal for VoIP according to the present invention.

### DETAILED DESCRIPTION OF PREFERRED EMBODIMENTS

The present invention provides an improved mechanism for NAT traversal for Voice over IP (VoIP). The new mechanism overcomes the shortcomings of existing NAT traversal mechanisms for VoIP, by enabling media traffic as early as possible, i.e. before the NAT status is established.

Reference will now be made in detail to various embodiments of the present invention. It will be understood that the disclosure is not intended to limit the invention to any particular embodiments. On the contrary, the invention is intended to cover alternatives, modifications and equivalents, which may be included within the spirit and scope of the disclosure and the attached claims. As will be appreciated by one of skill in the art, the present invention may be embodied as a method, data processing system or computer software program products. Accordingly, the present invention may take the form of data analysis systems, methods, analysis software and etc. Software written according to the present invention may be stored in some form of computer readable medium, such as memory, or hard-drive, CD-ROM. The software may be transmitted over a network and executed by a processor in a remote location. The software may also be embedded in the computer readable medium of hardware, such as a network gateway device or a network card.

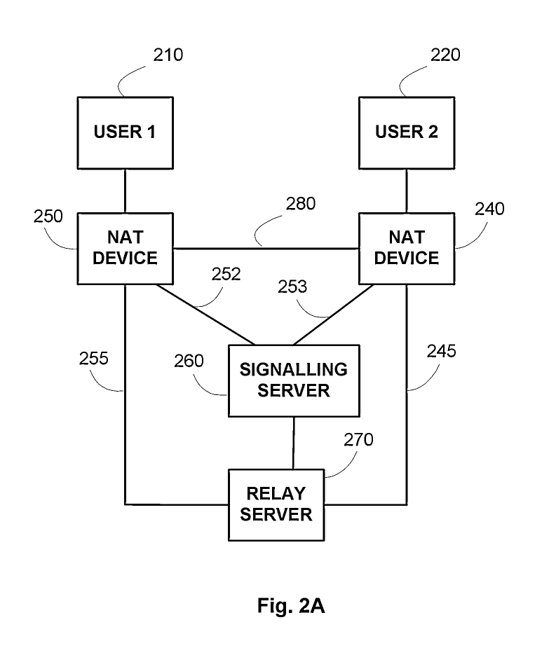

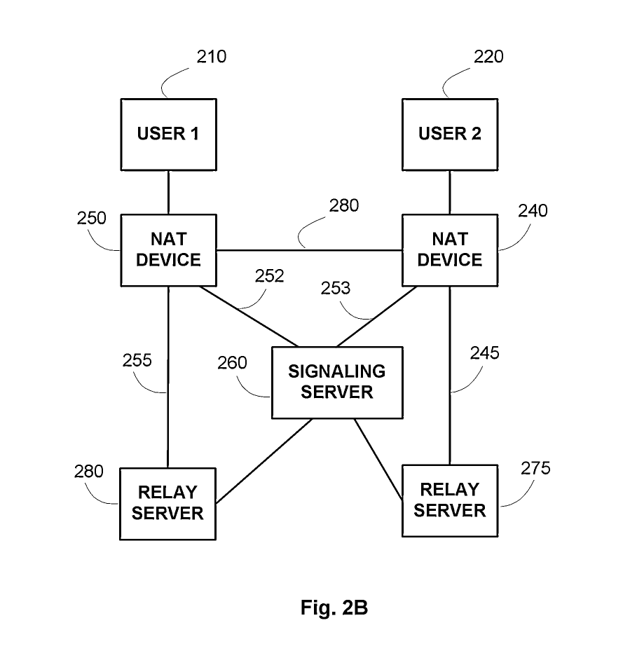

FIG. 2A is a schematic block diagram of the system and communication routes according to embodiments of the present invention.

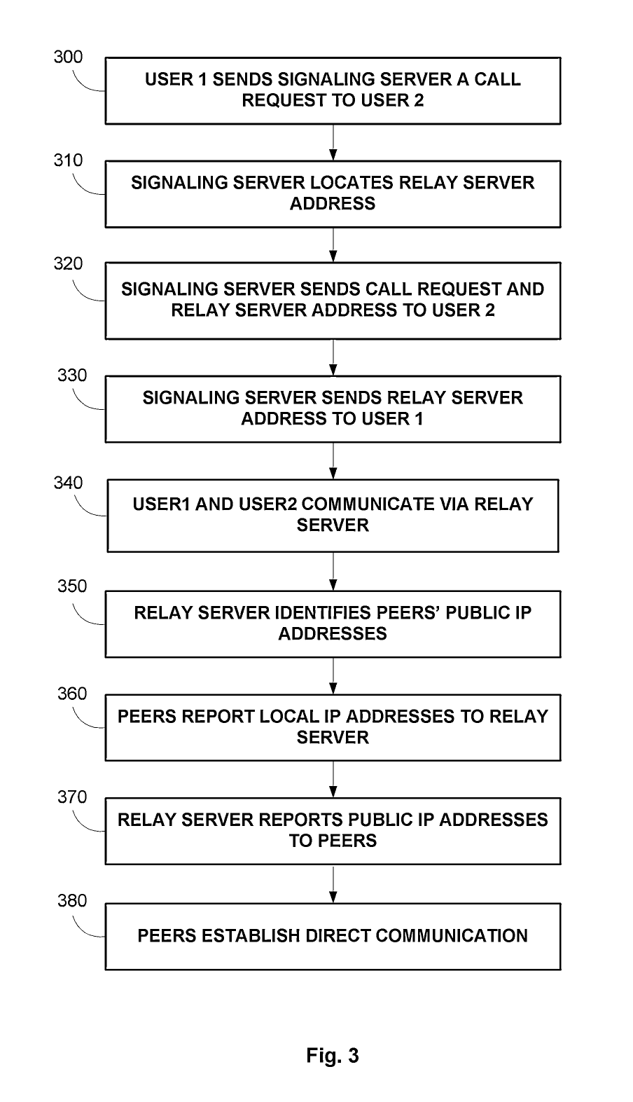

FIG. 3 is a flowchart outlining the method of NAT traversal for VoIP according to the present invention.

User1 running a VoIP client application 210 and User2 running client application 220, both implementing the method of the present invention. Both users' VoIP devices (e.g. Smartphone or PC) are behind NATs (network address translation) (250 and 240 respectively).

In step 300 User1 wishes to call User2; User1's VoIP client application 210 (e.g. Viber client) sends 252 a Call Request to a signaling server 260.

In step 310, signaling server 260 locates the IP address of the application relay server 270. This may be done in one of several ways known in the art such as, for example, signaling server 260 storing a list of relay servers, or the relay server having registered to the signaling service. Signaling server 260 then sends 253 the relay server's IP address to User2's client application 220, for establishing the call, along with the Call Request (step 320). In step 330 the signaling server sends 252 the relay server's IP address to User1's client application 210, for establishing the call.

Users1 and 2 may immediately start their call (245, 255) via the relay server 270 (step 340).

In step 350, the relay server 270 now identifies both peers' public IP addresses, by the addresses from which packets are arriving.

In step 360 the peers report their local IP addresses to the relay server 260 via a special message (this can be a periodic message or stop once the relay acknowledged the reception of the message).

In step 370 the relay server 270 reports to each client its peer's public and optionally private addresses. This may be done in one of several ways, such as:
Relay server 270 reports addresses back to signaling server 260 which can report back to clients
Relay server 270 reports directly to each client about peer on the “voice” channel, by multiplexing the voice (RTP data packets) and in-call signaling traffic Control Protocol (RTCP) packets.
Relay server 270 uses another channel to report (for example, each client has two connections to the relay server: one for RTP/voice and another for RTCP/signaling. The RTCP channel can be used to report on RTP-related ports and addresses.
Relay server 270 reports to each client its own public address (via RTCP or via signaling server 260). Each client can now notify the peer—again, it can send the data via signaling server 260, or via RTCP.

In another embodiment, as depicted in FIG. 2B, two relay servers 275, 280 are assigned by the signaling server, one for each peer. According to this embodiment, User1's client application 210 receives from the signaling server 260 the IP address of the relay server 275 assigned to User2 and User2's client application 220 will receive from the signaling server 260 the IP address of the relay server 280 assigned to User1. Each peer reports its local IP address to the relay server assigned to the other peer. In particular, 210 can report its local address to 275 which will then add the public IP and send it to 220.

In case UDP (User Datagram Protocol) is used to communicate with the client (voice channel or RTCP), the packets may get lost, therefore some kind of reliability needs to be introduced—for example, the relay server 270 may keep sending the messages, waiting for the client to acknowledge their receipt—or just keep sending them, for example as part of a periodic update.

In step 380 the peers may now establish peer-to-peer communication 280, after having performed positive connectivity checks. The clients will also attempt to send messages to the peer's local IP address—in case at least one of the clients is not behind a NAT or that both are behind the same NAT. These messages may not contain media data, and may be used only to establish whether there is connectivity. Alternatively, the messages may contain media data and be sent both via the relay server 270 and to the peer's local IP address.

Once a client establishes that it can send data directly to the peer, it will start to do so, stopping sending media messages via the relay.

If the NAT traversal process fails, the clients will continue to use the relay.

Note that if User2 220 uses an iOS device, the message (320) may be a “remote notification” (push). In this case, User2's client application 220 may not be running when receiving the message, and the session will only start when the user performs an action (i.e. answers the call). In this case, it is impossible for client application 220 to discover its NAT setting prior to the user “answering” the call.

Although the present invention has been described in terms of various specific embodiments, it is to be understood that such disclosure is not to be interpreted as limiting. Various alterations and modifications will no doubt become apparent to those skilled in the art after reading the above disclosure. Accordingly, it is intended that the appended claims be interpreted as covering all alterations and modifications as fall within the true spirit and scope of the invention.

1. A method of communication between users' electronic communication devices connected to a network via NAT devices, comprising:
sending a call request to a signaling server by a first electronic communication device connected to a network via NAT device to communicate with a second electronic communication device;
locating by the signaling server a relay server IP address;
sending by the signaling server said call request and said relay server IP address to said second electronic communication device connected to a network via NAT device;
sending said relay server IP address to said first electronic communication device;
starting communication between said first and second electronic communication devices via the relay server; and
following said communication start:
identifying by the relay server said first and second electronic communication devices public addresses;
reporting by said first and second electronic communication devices their private IP addresses to said relay server;
reporting by said relay server to each of said first and second electronic communication devices the public and private IP addresses of its peer;
establishing connectivity by said first and second electronic communication devices; and
continuing the communication between said first and second electronic communication devices via said reported public and private IP addresses in a peer-to-peer mode upon establishing connectivity.

2. The method of claim 1, wherein said locating a relay server IP address comprises locating a relay server in a list of relay servers stored at the signaling server.

3. The method of claim 1, wherein said locating a relay server IP address comprises locating a relay server registered to the service of the signaling server.

4. The method of claim 1, wherein said identifying by the relay server said first and second electronic communication devices public IP addresses comprises identifying the IP addresses from which packets are arriving.

5. The method of claim 1, wherein said reporting by said relay server to each of said first and second electronic communication devices the public and private IP addresses of its peer comprises reporting said IP addresses to the signaling server.

6. The method of claim 1, wherein said reporting by said relay server to each of said first and second electronic communication devices the public and private IP addresses of its peer comprises reporting directly to each user its peer's IP addresses.

7. The method of claim 6, wherein said direct reporting comprises multiplexing voice and signaling packets on the same channel.

8. The method of claim 6, wherein said direct reporting comprises using different channels for voice communication and for signaling.

9. The method of claim 1, further comprising continuing the communication between said first and second electronic communication devices via the relay server if connectivity was not established.

10. A method of communication between users' electronic communication devices connected to a network via NAT devices, comprising:
sending a call request to a signaling server by a first electronic communication device to communicate with a second electronic communication device;
locating by the signaling server two relay servers' IP addresses;
assigning the first relay server to said first electronic communication device and assigning the second relay server to said second electronic communication device;
sending by the signaling server said call request and the first relay server's IP address to said second electronic communication device;
sending by the signaling server the second relay server's IP address to said first electronic communication device;
starting communication between said first and second electronic communication devices via the relay servers; and
following said communication start:
identifying by the first relay server said second electronic communication devices public address and identifying by the second relay server said first electronic communication devices public address;
reporting by said first electronic communication devices its private IP address to the second relay server;
reporting by said second electronic communication devices its private IP address to the first relay server;
reporting by said first relay server to said second electronic communication devices the public and private IP addresses of said first electronic communication devices;
reporting by said second relay server to said first electronic communication devices the public and private IP addresses of said second electronic communication devices;
establishing connectivity by said first and second electronic communication devices; and
continuing the communication between said first and second electronic communication devices via said reported public and private IP addresses in a peer-to-peer mode upon establishing connectivity.

11. The method of claim 10, wherein said locating each relay server's IP address comprises locating relay servers in a list of relay servers stored at the signaling server.

12. The method of claim 10, wherein said locating each relay server's IP address comprises locating relay servers registered to the service of the signaling server.

13. The method of claim 10, wherein said identifying by the relay servers said first and second electronic communication devices public IP addresses comprises identifying the IP addresses from which packets are arriving.

14. The method of claim 10, wherein said reporting by the relay servers to each of said first and second electronic communication devices the public and private IP addresses of its peer comprises reporting said IP addresses to the signaling server.

15. The method of claim 10, wherein said reporting by said relay servers to each of said first and second electronic communication devices the public and private IP addresses of its peer comprises reporting directly to each user its peer's IP addresses.

16. The method of claim 15, wherein said direct reporting comprises multiplexing voice and signaling packets on the same channel.

17. The method of claim 15, wherein said direct reporting comprises using different channels for voice communication and for signaling.

18. The method of claim 10, further comprising continuing the communication between said first and second electronic communication devices via the relay server if connectivity was not established.
